(19) United States
(12) Patent Application Publication
(10) Pub. No.: US 2012/0223530 A1
(43) Pub. Date: Sep. 6, 2012

(54) PROCESSING MACHINE

(75) Inventor: MING-CHANG LEE, Tu-Cheng (TW)

(73) Assignee: HON HAI PRECISION INDUSTRY CO., LTD., Tu-Cheng (TW)

(21) Appl. No.: 13/081,468

(22) Filed: Apr. 6, 2011

(30) Foreign Application Priority Data
Mar. 1, 2011 (TW) 100106690

(51) Int. Cl. H02K 7/10

(52) U.S. Cl. 290/1 C

(57) ABSTRACT

A processing machine includes a high-pressure fluid pipe for allowing high-pressure fluid to reciprocate, a power transfer module connected to the high-pressure fluid pipe, a counterweight flywheel connected to the power transfer module, and a power changing module connected to the counterweight flywheel. The power transfer module is operable to transfer reciprocating power from high-pressure fluid reciprocating in the high-pressure fluid pipe to the counterweight flywheel. The counterweight flywheel is driven to rotate to drive the power changing module to operate. The power changing module changes kinetic power of the counterweight flywheel into a different type of power.

### CROSS-REFERENCE OF RELATED APPLICATIONS

A relevant subject matter is disclosed in a pending U.S. patent application, entitled “ELECTRICITY GENERATING DEVICE”, with application Ser. No. 13/076,448, filed on Mar. 31, 2011, which is assigned to the same assignee as this present application.

### BACKGROUND

1. Technical Field

The present disclosure relates to a processing machine.

2. Description of Related Art

Currently, large processing machines, such as lathes, milling machines, injection molding machines, and machining centers, are controlled to reciprocate or rotate with high-pressure fluid. Normally, the high-pressure fluid energy has to be increased to achieve the desired processing effect, which causes energy waste.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an exemplary embodiment of a processing machine, the processing machine includes a counterweight flywheel.

FIG. 2 is a schematic, plan view of the counterweight flywheel of FIG. 1, showing a state of rotation.

FIG. 3 is a schematic, plan view of the counterweight flywheel of FIG. 1, showing a state of non-rotation when the counterweight flywheel is horizontally set.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

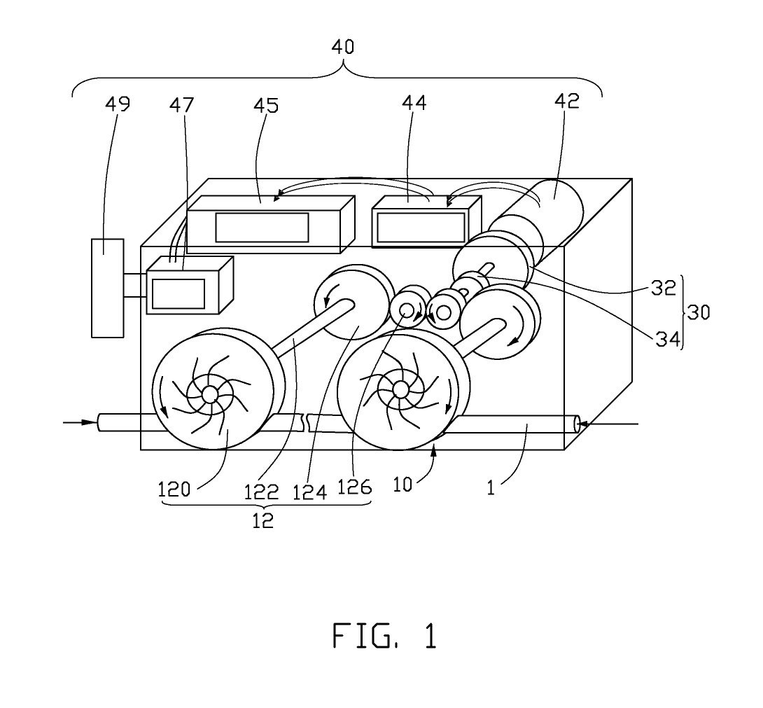

Referring to FIG. 1, an exemplary embodiment of a processing machine includes a high-pressure fluid pipe 1, a power transfer module 10, a counterweight flywheel 30, and a power changing module 40. The power transfer module 10 transfers reciprocating power from high-pressure fluid reciprocating in the high-pressure fluid pipe 1 to the counterweight flywheel 30. The counterweight flywheel 30 is driven to rotate, thereby driving the power changing module 40 to operate. The power changing module 40 changes kinetic power of the counterweight flywheel 30 to another type of power. In this embodiment, the power changing module 40 changes kinetic power of the counterweight flywheel 30 into electrical power for lighting.

The power transfer module 10 includes right and left power transfer assemblies 12. Each power transfer assembly 12 includes a one-way driving bearing 120, a first wheel 124, a second wheel 126, and an axle 122. Opposite ends of the axle 122 are respectively connected to the one-way driving bearing 120 and the first wheel 124. The first wheel 124 meshes with the second wheel 126. Two second wheels 126 of the right and left power transfer assemblies 12 mesh with each other. Each one-way driving bearing 120 includes a plurality of vanes therein. The one-way driving bearings 120 of the right and left power transfer assemblies 12 are connected in the high-pressure fluid pipe 1 symmetrically.

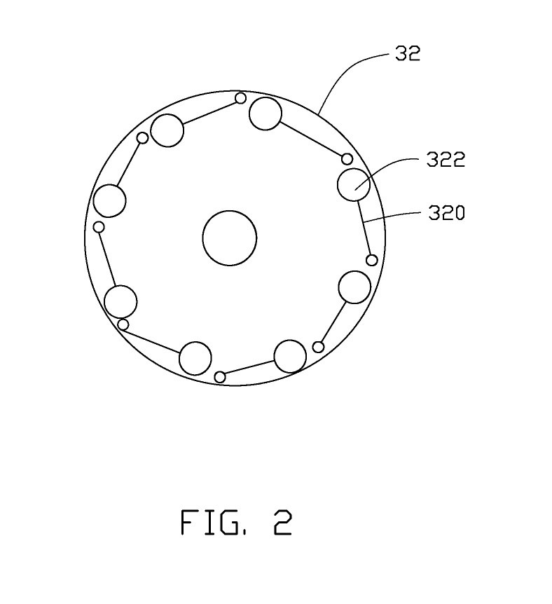

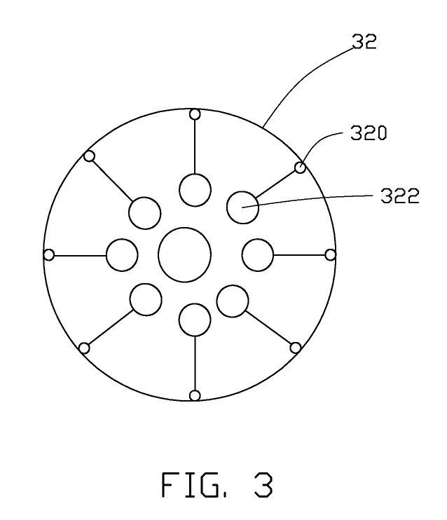

Referring to FIGS. 1-3, the counterweight flywheel 30 includes a flywheel body 32, and a clutch 34 installed on the flywheel body 32. The flywheel body 32 includes a plurality of elastic elements 320 connected to the flywheel body 32, adjacent to a circumference of the flywheel body 32, and a plurality of spherical weight bodies 322 each connected to a distal end of a corresponding one of the elastic elements 320. The weight bodies 322 can increase the inertia of the flywheel body 32. The weight bodies 322 connected to the elastic elements 320 can reduce extra physical strength to start the flywheel body 32. In this embodiment, each elastic element 320 is a spring. The clutch 34 is connected to the second wheel 126 of the right power transfer assembly 12.

The power changing module 40 includes a generator 42 connected to the flywheel body 32, a charge controller 44 electrically connected to the generator 42, a storage battery 45 electrically connected to the charge controller 44, a convertor 47 electrically connected to the storage battery 45, and a lighting circuit 49 electrically connected to the convertor 47.

In use, when high-pressure fluid moves to the left in the high-pressure fluid pipe 1, the high-pressure fluid drives the vanes of the driving bearings 120 to rotate clockwise. The left driving bearing 120 is in an idle condition. The right driving bearing 120 drives the right first wheel 124 to rotate clockwise with the corresponding axle 12. The right first wheel 124 drives the right second wheel 126 to rotate anticlockwise. The right second wheel 126 drives the flywheel body 32 to rotate anticlockwise and drives the left second wheel 126 to rotate clockwise. The flywheel body 32 drives the generator 42 to generate electricity.

When high-pressure fluid moves to the right in the high-pressure fluid pipe 1, the high-pressure fluid drives the vanes of the driving bearings 120 to rotate anticlockwise. The right driving bearing 120 is in an idling condition. The left driving bearing 120 drives the left first wheel 124 to rotate anticlockwise with the corresponding axle 12. The left first wheel 124 drives the left second wheel 126 to rotate clockwise. The left second wheel 126 drives the right second wheel 126 to rotate anticlockwise. The right second wheel 126 drives the flywheel body 32 to rotate anticlockwise. The flywheel body 32 drives the generator 42 to generate electricity.

When a direction of high-pressure fluid moving in the high-pressure fluid pipe 1 changes from left to right, a speed of the right second wheel 126 gears down first and then quickens, the flywheel body 32 can make the generator 42 stably generate electricity through inertia of the flywheel body 32.

Electricity from the generator 42 is stored in the storage battery 45 by the charge controller 44. The storage battery 45 supplies electricity to the lighting circuit 49 with the convertor 47.

In another embodiment, the clutch 34 is connected to the second wheel 126 of the left power transfer assembly 12

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

1. A processing machine comprising:
a high-pressure fluid pipe for allowing high-pressure fluid to reciprocate;
a power transfer module connected to the high-pressure fluid pipe;
a counterweight flywheel connected to the power transfer module; and
a power changing module connected to the counterweight flywheel;
wherein the power transfer module is operable to transfer reciprocating power from high-pressure fluid reciprocating in the high-pressure fluid pipe to the counterweight flywheel, the counterweight flywheel is driven to rotate to drive the power changing module to operate, the power changing module changes kinetic power of the counterweight flywheel into a different type of power.

2. The processing machine of claim 1, wherein the power changing module comprises a generator connected to the counterweight flywheel, a charge controller electrically connected to the generator, a storage battery electrically connected to the charge controller, an convertor electrically connected to the storage battery, and a lighting circuit electrically connected to the convertor.

3. The processing machine of claim 2, wherein the counterweight flywheel comprises a flywheel body connected to the generator.

4. The processing machine of claim 3, wherein the power transfer module comprises two power transfer assemblies, each power transfer assembly comprises a one-way driving bearing connected in the high-pressure fluid pipe, a first wheel, a second wheel meshing with the first wheel, and an axle connected to the one-way driving bearing and the first wheel, the flywheel body is connected to one of the second wheels of the two power transfer assemblies.

5. The processing machine of claim 4, wherein the two second wheels meshes with each other.

6. The processing machine of claim 4, wherein the counterweight flywheel further comprises a clutch set on the flywheel body, the flywheel body is connected to the one of the second wheels by the clutch.

7. The processing machine of claim 4, wherein the one-way driving bearings of the power transfer assemblies are arranged symmetrically.

8. The processing machine of claim 3, wherein a plurality of spherical weight bodies is movably attached to the flywheel body to increase the inertia of the flywheel body.

9. The processing machine of claim 8, wherein each weight body is movably attached to the flywheel body by an elastic member connected to an inner circumference of the flywheel body, for reducing extra physical strength to start the flywheel body.

10. The processing machine of claim 9, wherein the elastic member is a spring.
